(19) United States
(12) Patent Application Publication
(10) Pub. No.: US 2005/0259187 A1
(43) Pub. Date: Nov. 24, 2005

(54) Coupler structure for CRT projection TV

(75) Inventor: Chi Young Choi, Gyeongeongbuk-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/132,237

(22) Filed: May 19, 2005

(30) Foreign Application Priority Data
May 20, 2004 (KR) 10-2004-0035963

(51) Int. Cl. H04N 5/74

(52) U.S. Cl. 348/748

(57) ABSTRACT

A coupler structure for a CRT projection TV includes a coupler as a component of a CRT assembly positioned in the CRT projection TV, made up of a housing having an opening formed at the center thereof and a containing space formed therein with a predetermined depth and an extension extending outwardly from an upper edge of the housing with a coupling hole formed on the periphery of the extension. In the present invention, fluid interruption steps are formed with a predetermined height on the edge of the extension adjacent to the convex portion of the housing, and are formed around the coupling hole of the extension, respectively, in such a manner that electronic devices around the coupler are not damaged even if some of the cooling fluid which fills the containing space of the housing leaks out due to physical impact.

This nonprovisional application claims priority under 35 U.S.C. § 119(a) on Patent Application No. 10-2004-0035963 filed in Korea on May 20, 2004, which is herein incorporated by reference.

### BACKGROUND OF THE INVENTION

1. Field of the Invention

The present invention relates generally to a coupler structure for a CRT projection TV, and more particularly, to a coupler structure for a CRT projection TV making it possible to prevent cooling fluid contained in a coupler from leaking out and damaging electronic devices around the coupler when the coupler is subjected to physical impact, and to a coupler structure for a CRT projection TV making it possible to easily align the CRT with the coupler and fix the CRT thereto without an external assembly jig.

2. Description of the Background Art

Generally, a CRT projection TV 1 as shown in FIG. 1 is an image display apparatus for displaying larger images than the original by projecting images created from a CRT assembly 3 positioned within a cabinet 2 onto a large screen 5 positioned at the front surface of the cabinet 2.

The CRT assembly 3 as shown in FIG. 2 includes a CRT 6 for creating images, a coupler 7 positioned on the front surface of the CRT 6, and a projection lens 8 coupled to the outer surface of the coupler 7 to project the images created from the CRT 6 onto the screen 5 via the reflection mirror 4. A spring wire 6b is fixed around the funnel of the CRT 6 via a ground plate 6a, and CRT brackets 6c are coupled to both sides of the spring wire 6b.

The coupler 7 includes a housing 9 having an opening formed at the center of the upper and lower portions thereof, and a containing space 9a is formed therein for containing a predetermined volume of cooling fluid. An injection opening (not shown) is formed on a side of the housing 9 to allow the cooling fluid to be injected through the injection opening. A pressure regulation member (not shown) is positioned on the other side of the housing 9 to regulate the thermal expansion of the cooling fluid. An extension 10 extends outwardly from the upper edge of the housing 9. Bosses 11 are formed on an upper part of the extension 10 of the housing 9 to fix the projection lens 8 thereto, and bosses 11 are also formed on a lower part of the housing 9 to fix the CRT 6 thereto.

The projection lens 8 includes a group of lenses (not shown) for projecting images created from the CRT 6 onto the reflection mirror 4, an optical tube 8a for containing the group of lenses, and a lens bracket 8b integrally formed on the front edge of the optical tube 8a.

Sealing members 12 are positioned between the front surface of the CRT 6 and the extension 10 of the coupler 7, and between the convex portion of the coupler 7 and the lens bracket 8b of the projection lens 8, respectively, to prevent the cooling fluid in the containing space 9a of the coupler 7 from leaking out of the coupler 7.

A procedure for assembling the CRT 6 and the projection lens 8 to the coupler 7 will now be described with reference to FIGS. 2 to 4. The projection lens 8 is initially positioned on a working table (not shown) so that the lens bracket 8b of the projection lens 8 faces upward. The sealing member 12 is then positioned on the upper edge of the lens bracket 8b and the convex portion of the coupler 7 is aligned with the lens bracket 8b of the projection lens 8. The lens bracket 8b of the projection lens 8 is then fixed to the bosses 11 of the coupler 7 with screws.

Next, the fluorescent screen of the CRT 6 is aligned with the upper portion of the coupler 7, while the sealing member 12 is positioned on the upper edge of the coupler 7, and the CRT bracket 6c of the CRT 6 is then fixed to the bosses 11 of the coupler 7 with screws. Next, a predetermined volume of cooling fluid is injected through the injection opening (not shown) of the coupler 7, which is then sealed to complete the overall assembly procedure of the CRT assembly 3.

However, the background art has a problem in that, when the CRT assembly 3 is subjected to a physical impact, the sealing pressure between the coupler 7 and the projection lens 8 weakens and the cooling fluid in the containing space 9a of the housing 9 of the coupler 7 leaks out and damages the electronic devices positioned on the PCB below the coupler 7 (refer to FIGS. 3, 5, and 6). In addition, a jig must be used to assemble the CRT 6 and the coupler 7, in order to properly align the CRT 6 with the coupler 7. This makes the assembly procedure inconvenient and degrades the productivity of the product.

### SUMMARY OF THE INVENTION

The present invention has been made to solve the above-mentioned problems occurring in the background art.

It is an object of the present invention to provide a coupler structure for a CRT projection TV making it possible to prevent a cooling fluid which fills a containing space of a coupler housing from leaking out and damaging electronic devices around the coupler.

It is another object of the present invention to provide a coupler structure for a CRT projection TV making it possible to assemble a CRT and a coupler using the coupler's own structure without any additional jig.

In order to accomplish the above objects of the present invention, there is provided a coupler structure for a CRT projection TV including a coupler as a component of a CRT assembly positioned in the CRT projection TV, made up of a housing having an opening formed at the center thereof and a containing space formed therein with a predetermined depth, and an extension extending outwardly from an upper edge of the housing with a coupling hole formed in the periphery of the extension, wherein fluid interruption steps are formed with a predetermined height on the edge of the extension adjacent to a convex portion of the housing and around the coupling hole of the extension, respectively, in such a manner that electronic devices around the coupler are not damaged even if a part of the cooling fluid which fills the containing space of the housing leaks out due to a physical impact.

According to another aspect of the present invention, there is provided a coupler structure for a CRT projection TV including a coupler as a component of a CRT assembly positioned in the CRT projection TV, made up of a housing having an opening formed at the center thereof and a containing space formed therein with a predetermined depth, and an extension extending outwardly from an upper edge of the housing with a coupling hole formed in the periphery of the extension, wherein an engagement assistance guide is formed on the edge of the extension adjacent to a concave portion of the housing in such a manner that a CRT can be conveniently assembled to the coupler.

The foregoing and other objects, features and advantages of the present invention will become more apparent from the following detailed description when taken in conjunction with the accompanying drawings.

### BRIEF DESCRIPTION OF THE DRAWINGS

The accompanying drawings, which are included to provide a further understanding of the invention and are incorporated in and constitute a part of this application, illustrate an embodiment of the invention and together with the description serve to explain the principle of the invention. In the drawings:

FIG. 1 is a sectional view showing a background art CRT projection TV;

FIG. 2 shows the overall construction of a CRT assembly for a background art CRT projection TV;

FIG. 3 is a perspective view showing from above a coupler constituting a CRT assembly according to the background art;

FIG. 4 is a perspective view showing from below a coupler constituting a CRT assembly according to the background art;

FIG. 5 is a perspective view showing a CRT assembly according to the background art;

FIG. 6 shows the interconnection between a CRT assembly according to the background art and peripheral components;

FIG. 7 is a perspective view showing a coupler structure for a CRT projection TV according to the present invention;

FIG. 8 is a perspective view showing from above a coupler employed in a coupler structure for a CRT projection TV according to the present invention; and

FIG. 9 is a perspective view showing from below a coupler employed in a coupler structure for a CRT projection TV according to the present invention.

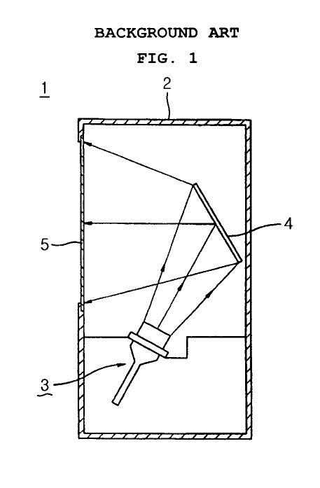

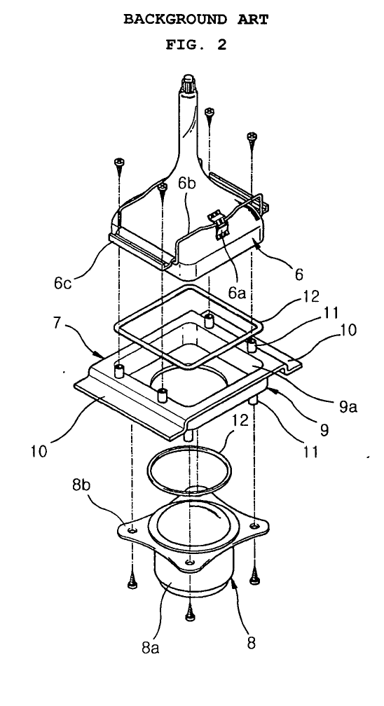

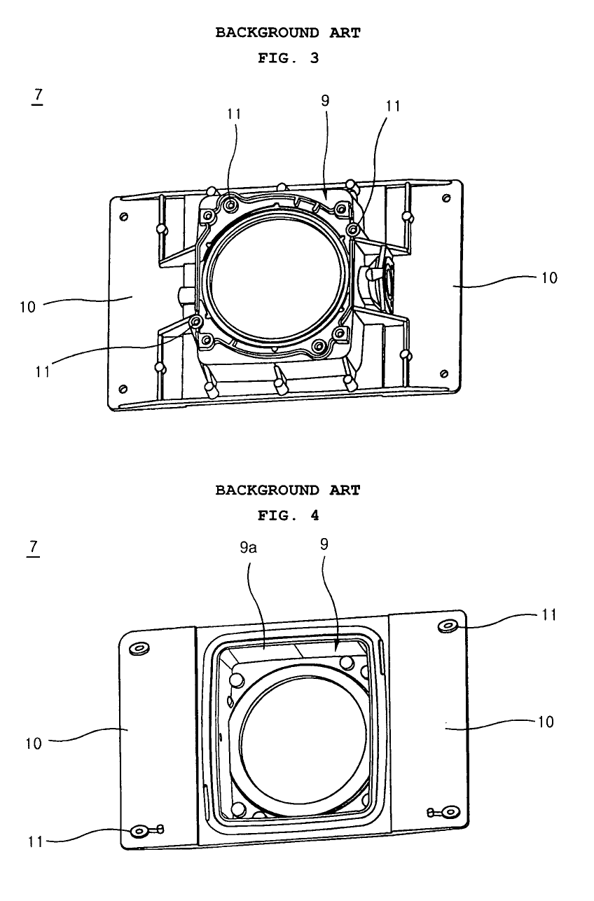

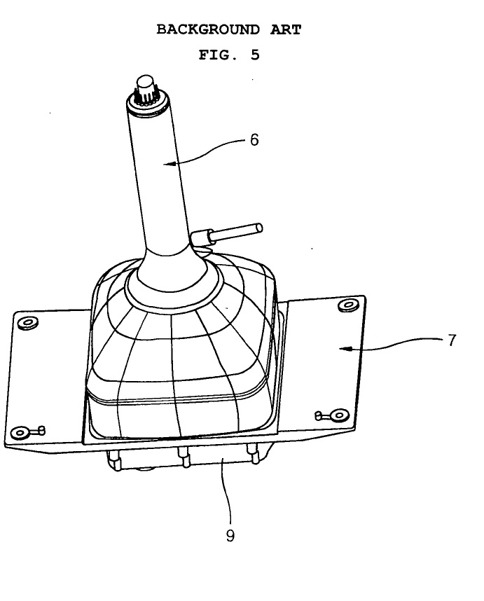

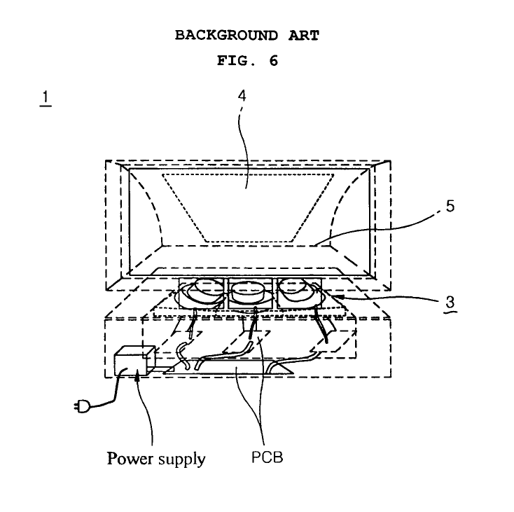

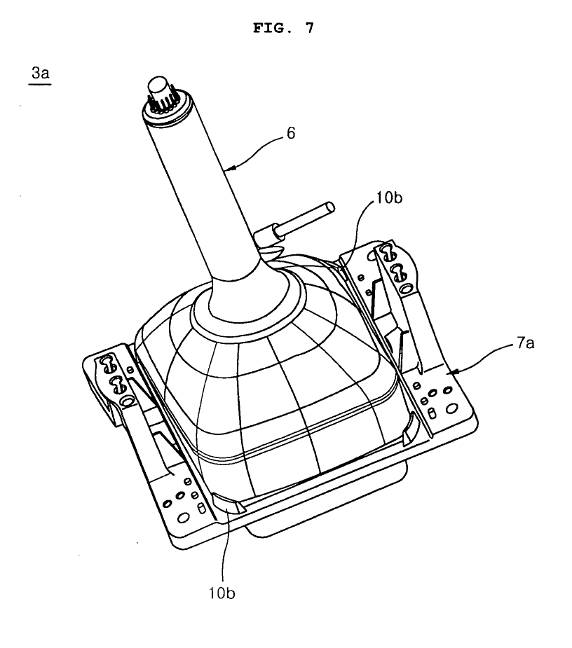

### DETAILED DESCRIPTION OF THE PREFERRED EMBODIMENT

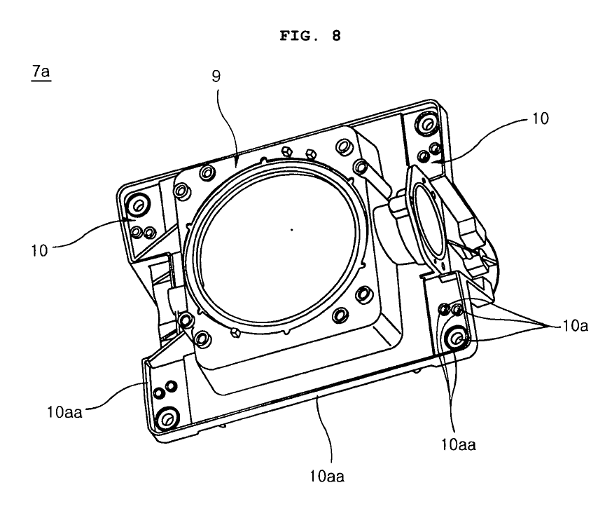

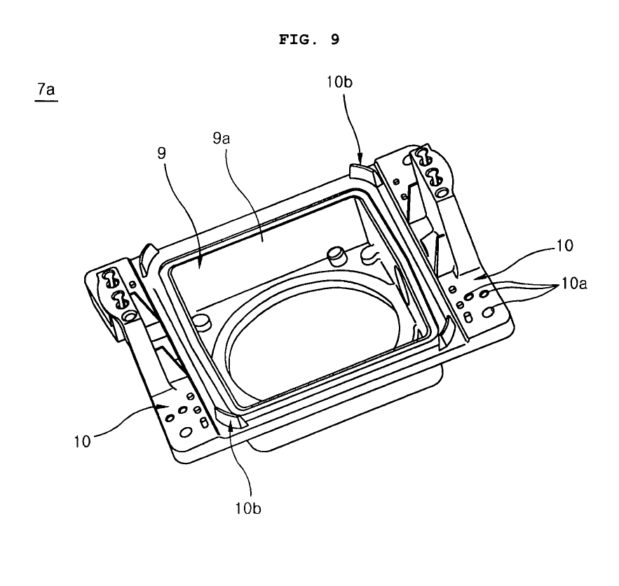

Hereinafter, reference will be made in detail to the preferred embodiment of the present invention with reference to FIGS. 7 to 9.

A coupler structure for a CRT projection TV according to the present invention includes a coupler 7a as a component of a CRT assembly 3a positioned in the CRT projection TV. The coupler 7a includes a housing 9 having an opening formed at the center thereof, and a containing space 9a formed therein with a predetermined depth. An extension 10 extends outwardly from an upper edge of the housing 9, and a plurality of coupling holes 10a are formed on the periphery of the extension 10. Fluid interruption steps 10aa are formed with a predetermined height on the edge of the extension 10 adjacent to the convex portion of the housing 9, and around the coupling hole 10a of the extension 10, respectively, in such a manner that electronic devices (not shown) around the coupler 7a are not damaged even if some of the cooling fluid which fills the containing space 9a of the housing 9 leaks out due to a physical impact.

A CRT 6 and a projection lens 8 are coupled to each other using the coupler 7a configured as above. The CRT assembly 3a includes the CRT 6, the coupler 7a, and the projection lens 8 positioned in the CRT projection TV for use. Even if the CRT projection TV is subjected to a physical impact or even if the cooling fluid in the coupler 7a is subjected to excessive heat from the CRT 6 during use and some of the cooling fluid leaks out between the coupler 7a and the projection lens 8, the leaking fluid is interrupted by the fluid interruption steps 10aa of the coupler 7a and is prevented from flowing onto electronic devices on a PCB below the coupler 7a.

In another aspect of the present invention, and as shown in FIG. 9, a plurality of engagement assistance guides 10b are formed on the edge of the extension 10 adjacent to the concave portion of the housing 9 in such a manner that a CRT 6 can be conveniently assembled to the coupler 7a. The engagement assistance guides 10b are positioned on the extension 10 to correspond to each of the four corners of the CRT 6. The engagement assistance guides 10b are arcuately shaped so that inner sides thereof that face a corresponding corner of the CRT 6 are rounded in order to center the CRT 6 and the coupler 7a.

The coupler 7a is positioned on a working table (not shown) so that the engagement assistance guides 10b of the coupler 7a faces upward, and a sealing member (not shown) is positioned on the corresponding edge of the extension 10 of the coupler 7a. The four corners of the CRT 6 are then aligned in such a manner that they are positioned inside the engagement assistance guides 10b adjacent to the extension 10 of the coupler 7a. In this manner, the central axis of the coupler 7a is automatically aligned with that of the CRT 6.

The CRT 6 and the coupler 7a, which have been automatically aligned with each other, are fixed with screws, and a projection lens (not shown) is engaged with and fixed to the convex portion of the housing 9 of the coupler 7a. The CRT 6, the coupler 7a, and the projection lens 8 are then fixed with screws using brackets and bosses. A cooling fluid is injected into the containing space 9a of the coupler 7a, which is then sealed for use.

As mentioned above, the present invention prevents the cooling fluid that fills the containing space of the coupler housing from leaking out and damaging electronic devices around the coupler. In addition, the present invention makes it possible to conveniently assembly the CRT and the coupler using the structure of the coupler itself without requiring the use of an additional jig.

The forgoing embodiments are merely exemplary and are not to be construed as limiting the present invention. The present teachings can be readily applied to other types of devices. The description of the present invention is intended to be illustrative, and not to limit the scope of the claims. Many alternatives, modifications, and variations will be apparent to those skilled in the art.

1. A coupler for a cathode ray tube (CRT) projection television (TV) having a CRT and a lens, the coupler being locatable between the CRT and the lens, the coupler comprising:
a housing having an opening formed at the center thereof, the housing including a containing space formed therein with a predetermined depth for receiving cooling fluid therein;
an extension extending outwardly from an edge of the housing, the extension having a coupling hole formed therein on the periphery of the extension;
a first fluid interruption step formed with a predetermined height around the edge of the extension; and
a second fluid interruption step located around the coupling hole,
whereby cooling fluid which may leak from the housing is contained in a space defined by the first and second fluid interruption steps.

2. The coupler according to claim 1, wherein the extension includes a plurality of the coupling holes therein.

3. The coupler according to claim 2, wherein each of the coupling holes has a second fluid interruption step located therearound.

4. The coupler according to claim 3, wherein the housing includes a convex portion.

5. The coupler according to claim 4, wherein the convex portion and the first fluid interruption step extend from the extension in a same direction.

6. The coupler according to claim 5, wherein the convex portion and the second fluid interruption step extend from the extension in the same direction.

7. The coupler according to claim 1, wherein the housing includes a convex portion.

8. The coupler according to claim 7, wherein the convex portion and the first fluid interruption step extend from the extension in a same direction.

9. The coupler according to claim 8, wherein the convex portion and the second fluid interruption step extend from the extension in the same direction.

10. A coupler for a cathode ray tube (CRT) projection television (TV) having a CRT and a lens, the coupler being locatable between the CRT and the lens, the coupler comprising:
a housing having an opening formed at the center thereof, the housing including a containing space formed therein with a predetermined depth for receiving cooling fluid therein;
an extension extending outwardly from an edge of the housing; and
a plurality of engagement assistance guide members formed on the extension to correspond to at least two corners of a CRT, the guide members having an arcuate shape for engaging corner portions of a CRT to thereby guide and align the CRT to the coupler.

11. The coupler according to claim 10, wherein four of the engagement assistance guide members are formed on the extension to correspond to each of four corners of a CRT.

12. The coupler according to claim 11, wherein the housing includes a concave portion into which the cooling fluid is placed.

13. The coupler according to claim 10, wherein the housing includes a concave portion into which the cooling fluid is placed.

14. A coupler for a cathode ray tube (CRT) projection television (TV) having a CRT and a lens, the coupler being locatable between the CRT and the lens, the coupler comprising:
a housing having an opening formed at the center thereof, the housing including a containing space formed therein with a predetermined depth for receiving cooling fluid therein;
an extension extending outwardly from an edge of the housing, the extension having a coupling hole formed therein on the periphery of the extension;
a first fluid interruption step formed with a predetermined height around the edge of the extension, and a second fluid interruption step located around the coupling hole, the first and second fluid interruption steps defining a space in which cooling fluid which may leak from the housing is contained; and
a plurality of engagement assistance guide members formed on the extension to correspond to at least two corners of a CRT, the guide members having an arcuate shape for engaging corner portions of a CRT to thereby guide and align the CRT to the coupler.

15. The coupler according to claim 14, wherein the extension includes a plurality of the coupling holes therein, each of the coupling holes having a second fluid interruption step located therearound.

16. The coupler according to claim 15, wherein the housing includes a convex portion which extends from the extension in a same direction as the first fluid interruption step.

17. The coupler according to claim 16, wherein the first fluid interruption step and the second fluid interruption steps extend from the extension in the same direction.

18. The coupler according to claim 17, wherein the first fluid interruption step and the engagement assistance guide members extend outwardly from the extension in opposite directions.

19. The coupler according to claim 18, wherein the housing includes a concave portion into which the cooling fluid is placed.

20. The coupler according to claim 19, wherein four of the engagement assistance guide members are formed on the extension to correspond to each of four corners of a CRT.
